(19) United States
(12) Patent Application Publication
(10) Pub. No.: US 2019/0050063 A1
(43) Pub. Date: Feb. 14, 2019

(54) DISPLAY APPARATUS AND METHOD FOR PROVIDING CONTENT THEREOF

(71) Applicant: SAMSUNG ELECTRONICS CO., LTD., Suwon-si (KR)

(72) Inventors: Seong-wook JEONG, Seoul (KR); Min-hyung KIM, Seoul (KR); Ga-min PARK, Seoul (KR); Hyo-seung PARK, Seoul (KR); So-yon YOU, Seoul (KR); Sang-joon LEE, Seoul (KR); Jun-woo LEE, Seoul (KR); Kyung-hwa JUNG, Anyang-si (KR)

(21) Appl. No.: 16/103,027

(22) Filed: Aug. 14, 2018

(30) Foreign Application Priority Data
Aug. 14, 2017 (KR) 10-2017-0103232

(51) Int. Cl. G06F 3/01; H04N 21/436; H04N 21/43; H04N 21/4402

(52) U.S. Cl. CPC G06F 3/017; H04N 21/440209; H04N 21/4307; H04N 21/43615

(57) ABSTRACT

A method for providing a content of a display apparatus is provided. The method for providing a content of a display apparatus includes sensing a user, performing a communication connection with the remote control device based on a content reproduction command being input to a remote control device after the user is sensed, receiving information on a content provided by an external display apparatus from the remote control device, and providing the content provided by the external display apparatus based on the information on the content.

### CROSS-REFERENCE TO RELATED APPLICATION

This application is based on and claims priority under 35 U.S.C. § 119 to Korean Patent Application No. 10-2017-0103232, filed on Aug. 14, 2017, in the Korean Intellectual Property Office, the disclosure of which is incorporated by reference herein in its entirety.

### BACKGROUND

### 1. Field

The present disclosure relates generally to a display apparatus and a method for providing a content thereof, and for example, to a display apparatus for continuously providing a content provided by an external display apparatus using a remote control device and a method for providing a content thereof.

### 2. Description of Related Art

Recently, a large number of display apparatuses are placed in a house. For example, not only in a living room, a display apparatus is also placed in a bedroom, a bathroom and a kitchen.

When a user moves from a living room to a bedroom and wishes to keep watching a content through a display apparatus in a bedroom followed by a display apparatus in a living room, there is an inconvenience in that a user cannot watch the content on the move or needs to set a reproduction time point of the content additionally through the display apparatus in the bedroom.

In addition, when a plurality of display apparatuses are controlled by a single remote controller, there is an inconvenience that an additional operation for communication connection (e.g., pairing) between a remote control device and a display apparatus needs to be performed.

### SUMMARY

An aspect of example embodiments of the present disclosure relates to providing a display apparatus for continuously providing a content provided by an external display apparatus using a single remote control device and a method for providing the content.

According to an example embodiment, a method for providing a content of a display apparatus is provided, the method including sensing a user, performing a communication connection with the remote control device based on a content reproduction command being input to a remote control device after the user is sensed, receiving information on a content provided by an external display apparatus from the remote control device, and providing the content provided by the external display apparatus based on the information on the content.

In a case where the remote control device transmits a stop command to the external display apparatus while the external display apparatus provides the content, the remote control device may receive and store the information on the content provided by the external display apparatus.

The information on the content provided by the external display apparatus may include reproduction information on a point of time when the stop command is input, wherein the providing comprises continuously providing a content provided by the external display apparatus at the point of time when the stop command is input based on the reproduction information on the point of time when the stop command is input.

The information on the content provided by the external display apparatus may include at least one of metadata information on a broadcast content, web address information on a web content, information on an application content, and information on a music content.

The providing may include displaying an inquiry message for reproducing the content provided by the external display apparatus based on the information on the content being received, and providing the content provided by the external display apparatus based on the information on the content based on a content reproduction command being input thorough the inquiry message.

The method may further include, releasing the communication connection with the remote control device based on the user not being sensed.

The method may further include, transmitting content reproduction information at a point of time when a stop command is input to the remote control device based on the stop command being received from the remote control device while the content is reproduced.

The performing of the communication connection may include receiving a pairing request signal from the remote control device based on the content reproduction command being input to the remote control device, identifying whether a user is sensed based on the pairing request signal being received, and transmitting a pairing response signal in response to the pairing request signal based on the user being sensed.

According to an example embodiment, a display apparatus is provided, the display apparatus including a sensor configured to sense a user, a communicator comprising communication circuitry configured to perform communication with a remote control device, a display, and a processor configured to control the communicator to perform a communication connection with a remote control device, based on a content reproduction command being input to the remote control device after a user is sensed through the sensor, to control the communicator to receive information on a content provided by an external display apparatus from the remote control device, and to control the display to provide the content provided by the external display apparatus based on the information on the content.

In a case where the remote control device transmits a stop command to the external display apparatus while the external display apparatus provides the content, the remote control device may receive and store the information on the content provided by the external display apparatus.

The information on the content provided by the external display device may include reproduction information on a point of time when the stop command is input, wherein the processor is further configured to control the display to continuously provide a content provided by the external display apparatus at the point of time when the stop command is input based on the reproduction information on the point of time when the stop command is input.

The information on the content provided by the external display apparatus may include at least one of metadata information on a broadcast content, web address information on a web content, information on an application content, and information on a music content.

The processor may be further configured to control the display to display an inquiry message for reproducing the content provided by the external display apparatus based on the information on the content being received, and to control the display to provide the content provided by the external display apparatus based on the information on the content based on a content reproduction command being input through the inquiry message.

The processor may be further configured to control the communicator to release a communication connection with the remote control device based on the user not being sensed through the sensor.

The processor may be further configured to control the communicator to transmit content reproduction information at a point of time when a stop command is input to the remote control device based on the stop command being received from the remote control device while the content is reproduced.

The processor may be further configured to receive a pairing request signal from the remote control device through the communicator based on the content reproduction command being input to the remote control device, identify whether a user is sensed based on the pairing request signal being received, and perform the communication connection by transmitting a pairing response signal in response to the pairing request signal through the communicator based on the user being sensed.

According to the above-described various example embodiments, a user may be provided with a content continue button by intuitively and conveniently using a plurality of display apparatuses.

### BRIEF DESCRIPTION OF THE DRAWINGS

The above and other aspects, features and attendant advantages of various example embodiments of the present disclosure will be more apparent and readily appreciated from the following detailed description, taken in conjunction with the accompanying drawings, in which like reference numerals refer to like elements, and wherein:

FIG. 1 is a diagram illustrating a content providing system according to an example embodiment of the present disclosure;

FIG. 2 is a block diagram illustrating an example configuration of a display apparatus according to an example embodiment of the present disclosure;

FIG. 3 is block diagram illustrating an example configuration of a display apparatus according to an example embodiment of the present disclosure;

FIG. 4 is a block diagram illustrating an example configuration of a remote control device according to an example embodiment of the present disclosure;

FIGS. 5A and 5B are diagrams illustrating an example method for continuously providing a content provided by an external display apparatus according to an example embodiment of the present disclosure;

FIG. 6 is a diagram illustrating an example inquiry message provided by a display apparatus according to an example embodiment of the present disclosure;

FIG. 7 is a flowchart illustrating an example method for providing a content of a display apparatus according to an example embodiment of the present disclosure; and

FIG. 8 is a sequence diagram illustrating an example method for providing a content of a content providing system according to an example embodiment of the present disclosure.

### DETAILED DESCRIPTION

The terms used in this disclosure will be briefly described, and the present disclosure will be described in greater detail.

The terms used in this disclosure including technical and scientific terms have the same meanings as would be generally understood by those skilled in the related art. However, these terms may vary depending on the intentions of the person skilled in the art, legal or technical interpretation, and the emergence of new technologies. In addition, some terms may be arbitrarily selected. These terms may be understood based on the meaning defined herein and, unless otherwise specified, may be understood based on the entire contents of this disclosure and common technical knowledge in the art.

The disclosure is not limited to the various example embodiments disclosed and described below and may be implemented in various forms and the scope of the disclosure is not limited to the following example embodiments. In addition, all changes or modifications derived from the meaning and scope of the claims and their equivalents should be understood as being included within the scope of the present disclosure. In the following description, a configuration which is publicly known but not relevant to the gist of the present disclosure may be omitted for clarity.

The terms such as “first,” “second,” and so on may be used to describe a variety of elements, but the elements should not be limited by these terms. The terms are used simply to distinguish one element from other elements.

The singular expression also includes the plural meaning as long as it does not conflict with the context. In this disclosure, terms such as ‘include’ and ‘have/has’ should be understood as designating that there are such characteristics, numbers, operations, elements, components or a combination thereof in the disclosure, not to exclude the existence or possibility of adding one or more of other characteristics, numbers, operations, elements, components or any combination thereof.

In an example embodiment, ‘a module’, ‘a unit’, or ‘a part’ perform at least one function or operation, and may be realized as hardware, such as a processor or integrated circuit, software that is executed by a processor, and/or any combination thereof. In addition, a plurality of ‘modules’, a plurality of ‘units’, or a plurality of ‘parts’ may be integrated into at least one module and may be realized as at least one processor (not shown) except for ‘modules’, ‘units’ or ‘parts’ that should be realized in a specific hardware.

When an element is referred to as being “connected” or “coupled” to another element, it can be directly connected or coupled to the another element or be indirectly connected or coupled to the another element with one or more intervening elements interposed therebetween. In addition, when an element is referred to as “including” a component, this indicates that the element may further include another component instead of excluding another component unless there is different disclosure.

Hereinafter, various example embodiments of the present disclosure will be described in greater detail with reference to the accompanying drawings so that those skilled in the art can easily understand and carry out the present disclosure. However, the present disclosure may be embodied in many different forms and is not limited to the example embodiments described herein. In order to clearly illustrate the present disclosure in the drawings, some of the elements that are not essential to the complete understanding of the disclosure may be omitted for clarity, and like reference numerals refer to like elements throughout the specification.

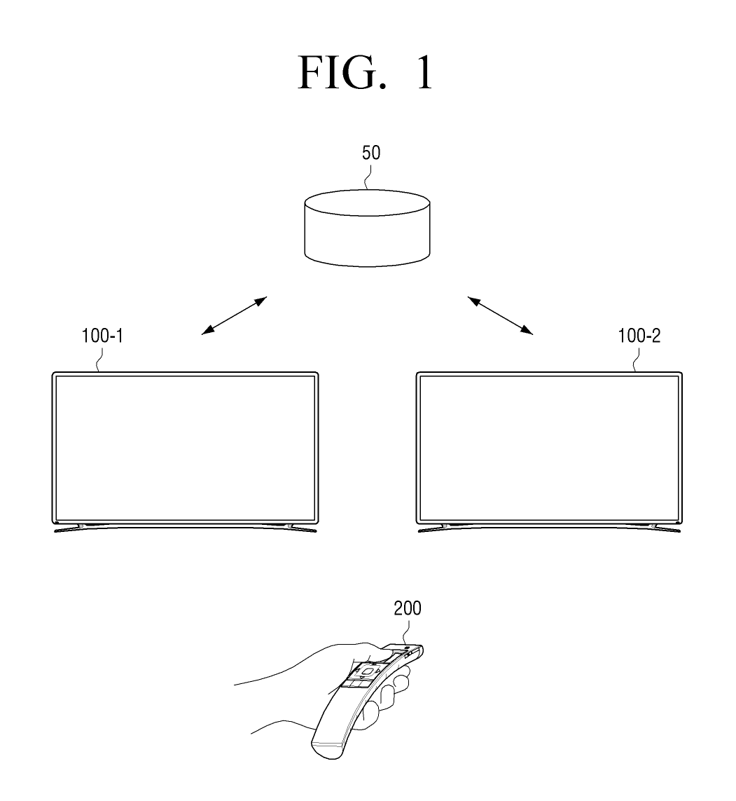

FIG. 1 is a diagram illustrating an example content providing system according to an example embodiment of the present disclosure. A content providing system, referring to FIG. 1, may include a first display apparatus 100-1, a second display apparatus 100-2, a remote control device 200 and an external apparatus 50. The first display apparatus 100-1 and the second display apparatus 100-2 may be embodied, for example, and without limitation, as a smart TV, but the disclosure is not limited thereto and may be embodied as various types of display apparatuses such as, for example, and without limitation, set-top boxes, desktop PCs, notebook PCs, tablet PCs, kiosks that can provide video contents, or the like. The remote control device 200 may be embodied as an integrated remote controller that can control a plurality of display apparatuses, but is not limited thereto, and may be embodied various types of portable terminals such as, for example, and without limitation, a smart phone, a PDA, or the like. The external apparatus 50 may be embodied as apparatuses such as, for example, and without limitation, a server, a DVDP, a game machine, or the like, for providing contents to a display apparatus.

The first display apparatus 100-1, and the second display apparatus 100-2 may be disposed in separate places from each other. For example, the first display apparatus 100-1 may be disposed in a bedroom, and the second display apparatus 100-2 may be disposed in a living room.

While the second display apparatus 100-2 is controlled by the remote control device 200 (e.g., when a user with the remote control device 200 is in a living room), the second display apparatus 100-2 may provide a content. The content may be a video content, but is not limited thereto, and may be an audio content.

When a content stop command is input to the remote control device 200 while the second display apparatus 100-2 provides a content, the remote control device 200 may transmit a stop command to the second display apparatus 100-2. The stop command may include a query that requests information on a content.

In response to the stop command, the second display apparatus 100-2 may stop a reproduced content, and transmit the information on the content to the remote control device 200. The information on the content may be information on a content which is reproduced by the second display apparatus 100-2, and may include identification information for identifying a content as well as reproduction information. The information on the content may also include information on the second display apparatus 100-2.

The remote control device 200 may store information on a content received from the second display apparatus 100-2.

When a user moves from a living room to a bedroom, the first display apparatus 100-1 may sense a user with the remote control device 200. The first display apparatus 100-1 may sense a user through various types of sensing devices such as, for example, and without limitation, a camera, an infrared sensor, or the like.

When a content reproduction command is input to the remote control device 200, the first display apparatus 100-1 may perform a communication connection with the remote control device 200. For example, when a content reproduction command is input to the remote control device 200, the remote control device 200 may transmit a pairing request signal to the first display apparatus 100-1. When receiving a pairing request signal, the first display apparatus 100-1 may determine whether a user is sensed. When the user is sensed, the first display apparatus 100-1 may transmit a pairing response signal in response to the pairing request signal. When the pairing response signal is transmitted, the remote control device 200 and the first display apparatus 100-1 may perform a communication connection.

When the communication connection is performed, the remote control device 200 may transmit a content reproduction command as well as information on the stored content to the first display apparatus 100-1.

The first display apparatus 100-1 may request a content reproduced by the second display apparatus 100-2 to the external apparatus 50 based on information on a content and reproduce the content reproduced by the second display apparatus 100-2. The first display apparatus 100-1 may continuously reproduce a content from a point of time when a stop command is input to the second display apparatus 100-2 based on reproduction information included in the information on the content.

When a user is not sensed while the first display apparatus 100-1 provides a content, the first display apparatus 100-1 may block the communication connection with the remote control device 200.

According to an embodiment as described above, a user can continuously watch a content through a plurality of display apparatus 100-1 and 100-2 located in a plurality of places and a single remote control device.

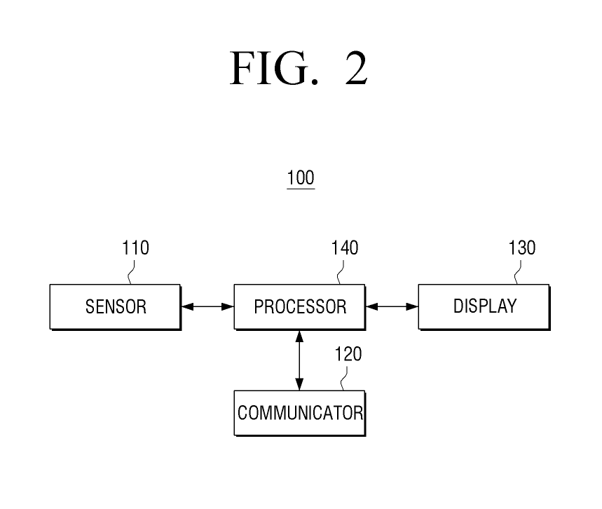

FIG. 2 is a block diagram illustrating an example configuration of a display apparatus according to an example embodiment of the present disclosure. Referring to FIG. 2, a display apparatus 100 may include a sensor 110, a communicator (e.g., including communication circuitry) 120, a display 130 and a processor (e.g., including processing circuitry) 140. As described above, the display apparatus 100 may, for example, and without limitation, be a smart TV, but is not limited thereto, and may be embodied as another display apparatus that could provide a video content. In addition, the technical spirit of the disclosure could be applied to various devices (e.g., a set-top box, or the like) that could provide a video content without the display 130.

The sensor 110 may detect a user. The sensor 110 may sense a user using a sensing device such as, for example, and without limitation, a camera, an infrared sensor, or the like.

The communicator 120 may include various communication circuitry and perform communication with various external apparatuses. The communicator 120 may perform communication with the remote control device 200. The communicator 120 may receive a content reproduction command or a content stop command from the remote control device 200 or transmit information on a content to the remote control device 200. The communicator 120 may perform communication with the external apparatus 50. The communicator 120 may receive a video content from the external apparatus 50.

The display 130 may provide various video contents or UIs. The display 130 may receive various video contents from the external apparatus 50.

The processor 140 may include various processing circuitry and control the overall operation of the display apparatus 100. When a content reproduction command is input to the remote control device 200 after a user is sensed through the sensor 110, the processor 140 may control the communicator 120 to perform a communication connection with a remote control device. The processor 140 may control the communicator 120 to receive information on a content provided by an external display apparatus from the remote control device 200, and control the display 130 to provide a content provided by the external display apparatus based on the information on the content.

When a content reproduction command is input to the remote control device 200, the processor 140 may receive a pairing request signal from the remote control device through the communicator 120. When the pairing request signal is received, the processor 140 may identify whether a user is sensed. When it is determined that the uses is sensed, the processor 140 may transmit a pairing response signal by responding to the pairing request signal through the communicator 120 to perform the communication connection.

When the communication connection is performed, the processor 140 may receive the information on the content provided by the external display apparatus from the remote control device 200 through the communicator 120. The information on the content may be information received and stored by the remote control device 200 from the external display apparatus when the remote control device 200 transmits a stop command to the external display apparatus while the external display apparatus provides a content. For example, the information on the content may include at least one of metadata information on a broadcast content, web address information on a web content, information on an application content, and information on a music content. The information on the content may include identification information on the content provided by the external display apparatus and reproduction information on a point of time when a stop command is input to the external display apparatus.

The processor 140 may control the display 130 to provide a content based on the information on the content received from the remote control device 200. When the information on the content is received, the processor 140 may control the display 130 to display an inquiry message for reproducing the content provided by the external display apparatus. When a content reproduction command is input through an inquiry message, the processor 140 may control the display 130 to provide the content provided by the external display apparatus based on the information on the content. The processor 140 may control the display 130 so that an external display apparatus provides a content provided at a point of time when a stop command is input based on reproduction information on the point of time when the stop command is input.

When a stop command is received from the remote control device 200 while a content is reproduced, the processor 140 may control the communicator 120 to transmit information on a content to the remote control device 200. The processor 140 may control the communicator 120 to transmit content reproduction information at a point of time when a stop command is input to the remote control device 200.

In addition, when the user is not sensed through the sensor 110, the processor 140 may control the communicator 120 to release the communication connection with the remote control device 200.

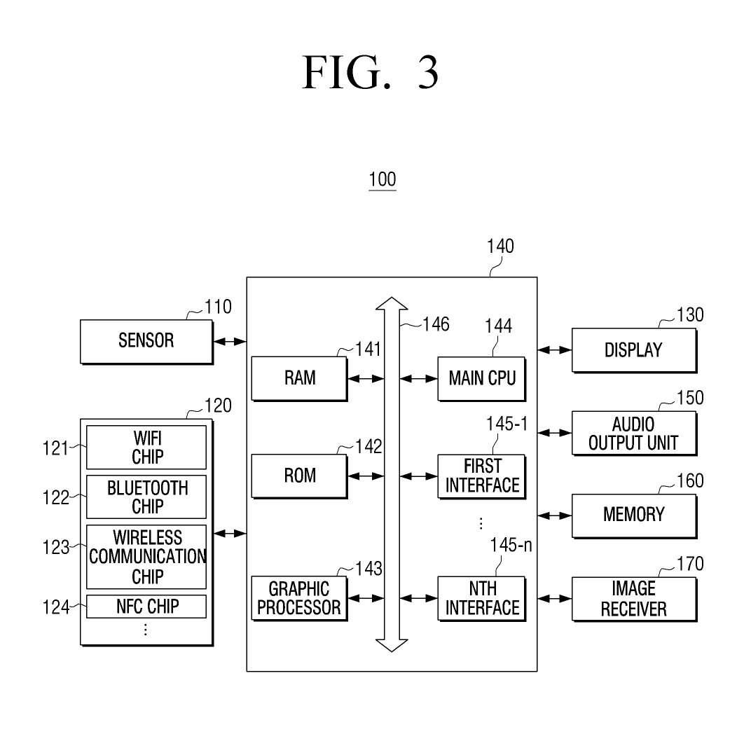

FIG. 3 is block diagram illustrating an example configuration of a display apparatus according to an example embodiment of the present disclosure. Referring to FIG. 3, a display apparatus 100 may include a sensor 110, a communicator (e.g., including communication circuitry) 120, a display 130, an audio output unit (e.g., including audio output circuitry) 150, a memory 160, an image receiver (e.g., including image receiving circuitry) 170 and a processor (e.g., including processing circuitry) 140. The configuration of the display apparatus 100 illustrated in FIG. 3 is merely an example, and is not limited thereto. Therefore, it should be understood that the configuration of the display apparatus 100 may be partly omitted, changed, or added according to the type or purpose of the display apparatus 100.

The sensor 110 may sense a user. The sensor 110 may identify whether a user is sensed at a position where the display apparatus 100 is disposed using various sensors. For example, the sensor 110 may capture a front area of the display apparatus 100 using a camera (or a depth camera), and determine whether the user is sensed in the captured front area. The sensor 110 may determine whether the user is present in the front area of the display apparatus 100 through various sensors such as, for example, and without limitation, an infrared sensor, or the like.

The communicator 120 may include various communication circuitry and perform communication with various types of external apparatuses according to various types of communication methods. The communicator 120 may include various communication circuitry included in various communication chips, such as, for example, and without limitation, at least one of a Wi-Fi chip 121, a Bluetooth chip 122, a wireless communication chip 123, and an NFC chip 124. The processor 140 may perform communication with an external server or various external apparatuses using the communicator 120.

For example, each of the Wi-Fi chip 121 and the Bluetooth chip 122 may perform communication using the WiFi method or the Bluetooth method. In case of using the Wi-Fi chip 121 or the Bluetooth chip 122, various connection information such as an SSID and a session key may be transmitted and received first, communication connection may be performed using the connection information, and various information may be transmitted and received. The wireless communication chip 123 refers to a chip that performs communication according to various communication standards such as IEEE, Zigbee, 3rd Generation (3G), 3rd Generation Partnership Project (3GPP), Long Term Evolution (LTE), etc. The NFC chip 224 refers to a chip operating in an NFC (Near Field Communication) mode using 13.56 MHz band among various RF-ID frequency bands such as 135 kHz, 13.56 MHz, 433 MHz, 860 to 960 MHz and 2.45 GHz.

The communicator 120 may perform communication with a plurality of external apparatuses according to different communication methods. For example, the communicator 120 may perform communication with the remote control device 200 using a first communication method (e.g., a Bluetooth communication method). The communicator 120 may receive a content reproduction command, a content stop command, and information on a content from the remote control device 200 using the first communication method, and transmit the information on the content to the remote control device 200. The communicator 120 may receive a video content from an external server using a second communication method (for example, and without limitation, a Wi-Fi communication method, a wireless LAN communication method, or the like).

The display 130 may display various screens or UIs on a display area. The display 130 may display a video content provided by an external display apparatus, and display an inquiry message for inquiring the display of the video content provided by the external display apparatus.

Meanwhile, the display 130 may be implemented in various types or sizes of display panels. For example, and without limitation, the display panel may be embodied with a liquid crystal display (LCD), an organic light emitting diode (OLED), an active matrix organic light-emitting diode (AM-OLED), a liquid crystal on silicon (LcoS), Digital Light Processing (DLP), or the like.

The display 130 may include a touch screen having, for example, a layer structure in combination with a touch panel. The touch screen may include a display function as well as a sensing function of a touch input position, a touch area and a touch input pressure. In addition, the touch screen may include a sensing function of not only a real-touch but also a proximity touch.

The audio output unit 150 may include various audio output circuitry and output various alarming sounds or voice messages in addition to various audio data processed by an audio processor (not shown) based on various processes such as, for example, and without limitation, decoding, amplifying, noise filtering, or the like. The audio output unit 150 may include various audio output circuitry, such as, for example, and without limitation, a speaker, or the like, but is not limited thereto, and may be embodied as an output terminal that could output audio data.

The audio output unit 150 may provide audio data provided by an external display apparatus.

The memory 160 may store various programs and data required for the operation of the display apparatus 100. The memory 160 may include various types, such as, for example, and without limitation, a non-volatile memory, a volatile memory, a flash-memory, a hard disk drive (HDD) and/or a solid state drive (SDD). The memory 160 may accessed by the processor 140, and reading/writing/modifying/deleting/updating of data may be performed by the processor 140. According to the present disclosure, the term ‘a memory’ may include a memory 160 and a memory card (not shown) (e.g., a micro SD card, a memory stick, etc.) mounted on an ROM 142 or an RAM 141 in the processor 140 or the display apparatus 100. The memory 160 may include a buffer which temporarily stores various data of a music content.

The memory 160 may store programs and data for providing various screens to be displayed on a display area of the display 130.

The memory 160 may store metadata with respect to the presently reproduced content. The memory 160 may store information on the remote control device 200 when the communication connection (or pairing) is performed with the remote control device 200.

The image receiver 170 may include various image receiving circuitry and receive video contents from various sources from the outside. The image receiver 170 may include various image receiving circuitry, such as, for example, and without limitation, a tuner, a tuner terminal, or the like (e.g., an HDMI terminal, a USB terminal, or the like). The tuner may receive a broadcast content from an external broadcast station, and the communication terminal may be connected to an external apparatus (e.g., a set-top box, a DVDP, etc.) and receive a video content.

The processor 140 (or, a processor) may include various processing circuitry and control the overall operation of the display apparatus 100 using various programs stored in the memory 160.

The processor 140 may include, for example, and without limitation, a RAM 141, a ROM 142, a graphics processor 143, a main CPU 144, first to nth interfaces 145-1 to 145-n, and a bus 146. The RAM 141, the ROM 142, the graphics processor 143, the main CPU 144, the first to nth interfaces 145-1 to 145-n may be connected to one another via the bus 146.

The RAM 141 may store an O/S and an application program. Specifically, when the display device 100 is booted, the O/S may be stored in the RAM 141, and various application data selected by the user may be stored in the RAM 141.

The ROM 142 may store a command set for system booting, and the like. The main CPU 144 may copy the O/S stored in the memory 160 to the RAM 141 according to the command stored in the ROM 142, execute the O/S, and perform system booting. When the booting is completed, the main CPU 144 may copy various application programs stored in the memory 160 to the RAM 141, execute the application program copied to the RAM 141, and perform various operations.

The graphic processor 143 may generate a screen including various objects such as items, images, texts, etc. using a calculation unit (not shown) and a rendering unit (not shown). The calculation unit may calculate attribute values such as a coordinate, a shape, a size, a color, etc. of each object according to the layout of a screen using a control command received from various user input units (e.g., a communicator, a touch panel, etc.) The rendering unit may generate a screen in various layouts including objects based on attribute values calculated by the calculation unit. The screen generated by the rendering unit may be displayed in the display area of the display 130.

The main CPU 144 may access the memory 160, and perform booting using the O/S stored in the memory 160. The main CPU 144 may perform various operations using various programs, contents, data, etc. stored in the memory 160.

The first to nth interfaces 145-1 to 145-n may be connected to the various components described above. One of the first to nth interfaces 145-1 to 145-n may be a network interface connected to an external apparatus via a network.

When a content reproduction command is input after the user is sensed by the sensor 110, the processor 140 may control the communicator 120 to perform a communication connection with the remote control device 200. The processor 140 may control the communicator 120 to receive the information on the content provided by the external display apparatus from the remote control device 200, and control the display 130 to provide a content provided by an external display apparatus based on the information on the content.

When a content stop command is received from the remote control device 200 while a video content is provided, the processor 140 may control the communicator 120 to transmit information on the presently provided content to the remote control device 200. The information on the content may include identification information on the content and reproduction information on a point of time when a stop command is input.

The processor 140 may identify whether the user is sensed while performing communication with the remote control device 200. When the user is sensed, the processor 140 may maintain communication connection with the remote control device 200, and when the user is not sensed, the processor 140 may release the communication connection with the remote control device 200.

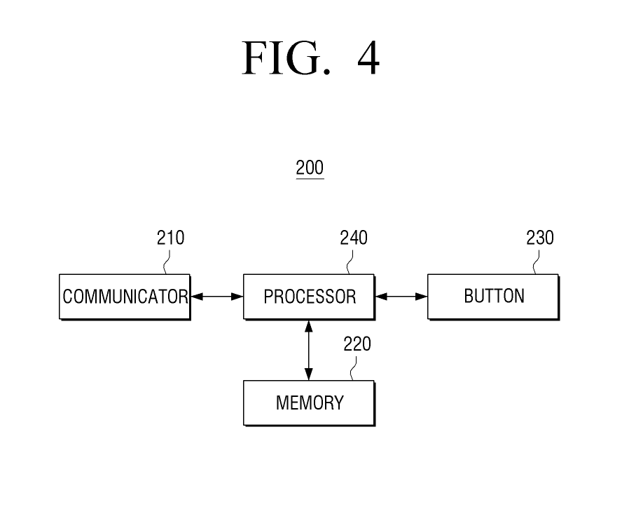

FIG. 4 is a block diagram illustrating an example configuration of a remote control device according to an example embodiment of the present disclosure. Referring to FIG. 4, a remote control device 200 may include a communicator (e.g., including communication circuitry) 210, a memory 220, a button 230 and a processor (e.g., including processing circuitry) 240. The remote control device 200 illustrated in FIG. 4 illustrates a typical remote controller, but when the remote control device 200 is embodied as another apparatus (e.g., a smart phone, or the like), an existing element may be deleted or a new element (e.g., a display, or the like) may be added.

The communicator 210 may include various communication circuitry and perform communication with the external display apparatus 100. The communicator 210 may perform communication with one of a plurality of display apparatuses 100, and communication connection with the display apparatus 100 may be performed according to a Bluetooth communication method.

The memory 220 may store various data for controlling the remote control device 200. The memory 220 may store information on a content transmitted from the external display apparatus 100. When the information on the content is transmitted to another display apparatus after the communication connection with another display apparatus is performed, the memory 220 may remove the information on the stored content.

The button 230 may receive various user commands for controlling the display apparatus 100. The button 230 may include a plurality of buttons such as, for example, and without limitation, an ok button, a replay button, a stop button, or the like.

The remote control device 200 may include a microphone for receiving a user voice command.

The processor 240 may include various processing circuitry and control the overall operation of the remote control device 200. When a stop button is selected from among the buttons 230, the processor 240 may control the communicator 210 to transmit a signal for requesting information on a content to the external display apparatus 100 together with a content stop command. The processor 240 may receive the information on the content from the external display apparatus 100 through the communicator 210 and store the information in the memory 220.

In addition, when a content reproduction command (e.g., a command for selecting a replay button, or a user voice command for content replay through a microphone) is input, the processor 240 may determine whether the communication connection with the external display apparatus is performed. When the communication connection with the external display apparatus is not performed, the processor 240 may control the communicator 210 to transmit a pairing request signal to the external display apparatus. When a paring response signal is transmitted in response to the pairing request signal, the communication connection may be performed with the external display apparatus. When the communication connection is performed with the external display apparatus, the processor 240 may control the communicator 210 to transmit the content reproduction command and the information on the content stored in the memory 220 to the external display apparatus.

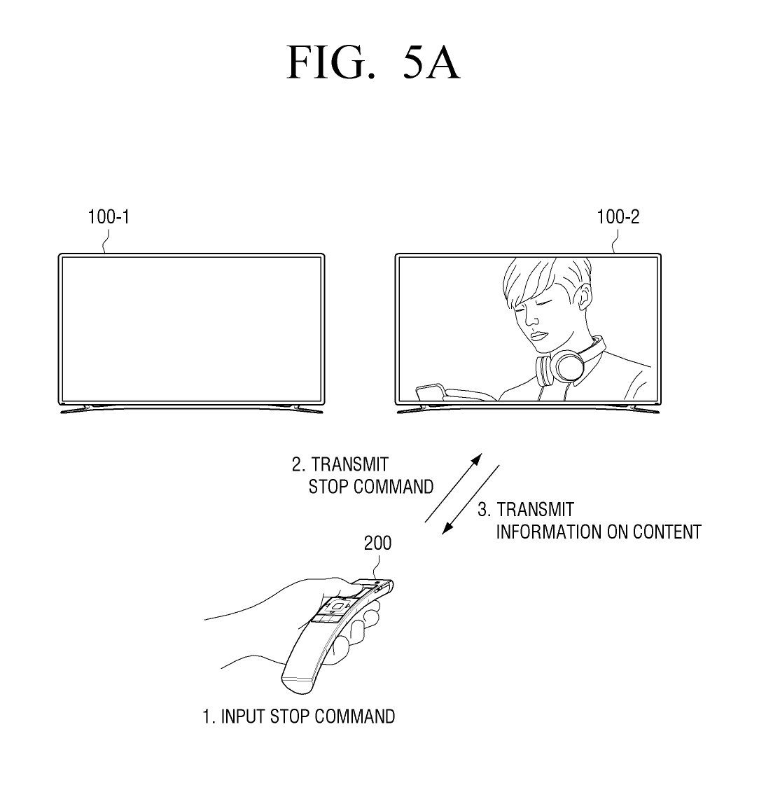

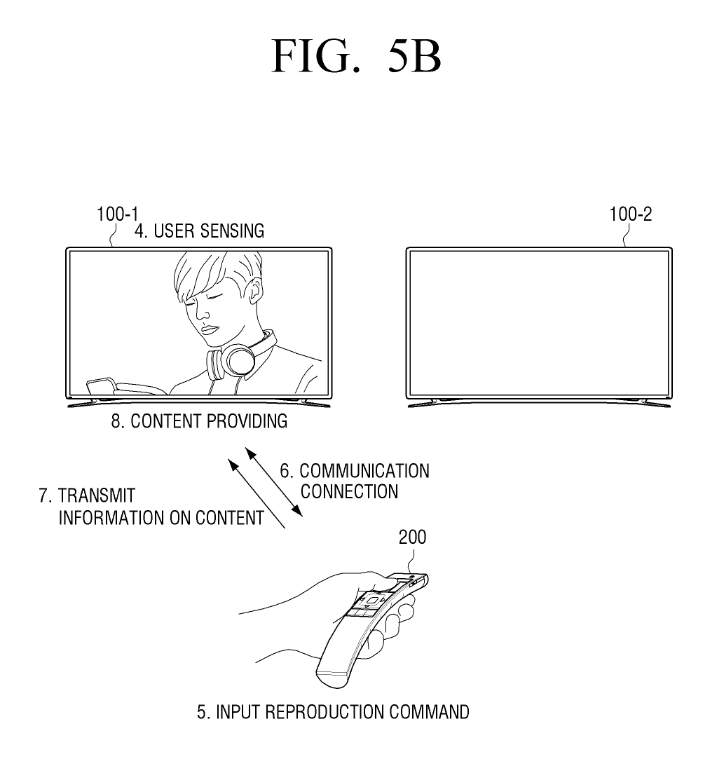

FIGS. 5A and 5B are diagrams illustrating an example method for continuously providing a content provided by an external display apparatus according to an example embodiment of the present disclosure.

Referring to FIG. 5A, the first display apparatus 100-1 may be in a standby mode, and the second display apparatus 100-2 may display a broadcast content. The standby mode may be a mode in which standby power is supplied to the first display apparatus 100-1 and only some of configurations (e.g., a camera, a communicator, etc.) are activated. The first display apparatus 100-1 could be in a standby mode, but is not limited thereto, and may be in a state in which another content is displayed.

The remote control device 200 may be communication connected with the second display apparatus 100-2, but may not be communication connected with the first display apparatus 100-1. In other words, the remote control device 200 may control the second display apparatus 100-2 between the first display apparatus 100-1 and the second display apparatus 100-2.

When a user inputs a stop command to the remote control device 200 (e.g., when a stop button included in the remote control device 200 is input) in a state where the remote control device 200 is communication connected with the second display apparatus 100-2, the remote control device 200 may transmit a stop command to the second display apparatus 100-2. The remote control device 200 may transmit a query for requesting information on a content provided by the second display apparatus 100-2 together with a stop command.

The second display apparatus 100-2 may stop the currently provided content in response to a stop command. The second display apparatus 100-2 may stop the content as well as changing a mode of the second display apparatus 100-2 to a standby mode. According to another embodiment, the second display apparatus 100-2 may stop the content in response to a stop command, and when a user is not sensed through the sensor 110 after the content is stopped, the second display apparatus 100-2 may release the communication connection between the second display apparatus 100-2 and the remote control device 200, and change a mode of the second display apparatus 100-2 to a standby mode.

The second display apparatus 100-2 may transmit information on a content to the remote control device 200 in response to a query for requesting the information on the content provided by the second display apparatus 100-2. Information on a content may be the information on the content provided by the second display apparatus 100-2 at a point of time when a stop command is input, and may include identification information for identifying a content. For example, the information on the content may include at least one of metadata information on a broadcast content, web address information on a web content, information on an application content, and information on a music content.

When the content provided by the second display apparatus 100-2 is a broadcast content, the information on the content may, for example, and without limitation, include a channel name, a program name, and a present channel number of the broadcast content provided by the second display apparatus 100-2, which is obtained through metadata of the broadcast content. When the content provided by the second display apparatus 100-2 is a web content, the information on the content may include address information of a present website. When the content provided by the second display apparatus 100-2 is an application content, the information on the content may, for example, and without limitation, include a name, version information, download information, or the like, of an application. When the content provided by the second display apparatus 100-2 is a music content, the information on the content may, for example, and without limitation, include the name of the music content, information on a music application, information on a space where the music content is stored, information of a content provider that provides the music content, or the like.

The information on the content may include reproduction information on a point of time when a stop command is input. When the stop command is input 13 (thirteen) minutes after a broadcast content is reproduced while the second display apparatus 100-2 provides a broadcast content, the information on the content may include reproduction information indicating that a reproduction time of the broadcast content is thirteen minutes. The information on the content may also include the information on the second display apparatus 100-2 (e.g., a positon, a product name, an owner name, etc. of the second display apparatus 100-2).

When the information on the content is received, the remote control device 200 may store the information on the content.

After the remote control device 200 stores the information on the content, a user may move beyond the area where the second display apparatus 100-2 is disposed and move to a position where the first display apparatus 100-1 is positioned.

Referring to FIG. 5B, the first display apparatus 100-1 may sense a user. The first display apparatus 100-1 may sense the user using, for example, a camera, but is not limited thereto, and may sense the user using another sensor.

The remote control device 200 may receive a reproduction command from the user. The reproduction command may include a command for selecting a specific button (e.g., a reproduction button) of the remote control device 200 or a user voice command input through a microphone included in the remote control device 200.

When a reproduction command is input to the remote control device 200, the remote control device 200 may perform communication connection with the first display apparatus 100-1. The remote control device 200 may transmit a pairing request signal to the first display apparatus 100-1. The first display apparatus 100-1 may identify whether a user is sensed in response to the pairing request signal. When it is identified that the user is sensed, the first display apparatus 100-1 may transmit a pairing response signal to the remote control device 200 in response to the pairing request signal. However, if the remote control device 200 has never been communication connected with the first display apparatus 100-1, (or pairing), the remote control device 200 and the first display apparatus 100-1 may go through a registration process for pairing.

After the communication connection is performed, the remote control device 200 may transmit information on a content to the first display apparatus 100-1 together with a content reproduction command.

The first display apparatus 100-1 may provide the content provided by the second display apparatus 100-2 based on the information on the content. When the content provided by the second display apparatus 100-2 is a broadcast content, the first display apparatus 100-1 may continue to reproduce the content provided by the second display apparatus 100-2 based on a channel name, a broadcast program name, a reproduction time with respect to the broadcast content. In addition, when the content provided by the second display apparatus 100-2 is a web content, the first display apparatus 100-1 may access a web content based on address information of a webpage. When the content provided by the second display apparatus 100-2 is an application content, the first display apparatus 100-1 may identify whether an application is installed or updated based on the information on the application content, and if an application of the latest version is installed, an application may be executed straight away, and if an application of the latest version is not installed, an application of the latest version may be installed and executed. When the content provided by the second display apparatus 100-2 is a music content, the first display apparatus 100-1 may retrieve a music content from an external server (or a content provider) based on the information on the music content and provide the music content.

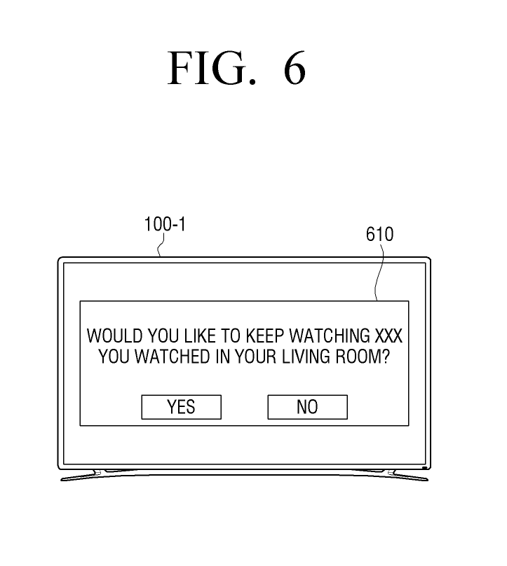

Before providing the content provided by the second display apparatus 100-2, as illustrated in FIG. 6, the first display apparatus 100-1 may display an inquiry message 610. For example, as shown in FIG. 6, the inquiry message 610 may include information such as “Would you like to keep watching xxx you watched in your living room?”

When it is selected to continue viewing the content through the inquiry message 610, the first display apparatus 100-1 may continuously provide the content provided by the second display apparatus 100-2.

When a stop command is input again through the remote control device 200 while a content is provided by the first display apparatus 100-1, the first display apparatus 100-1 may stop the reproduction of the content, and transmit information on the content reproduced by the first display apparatus 100-1 to the remote control device 200.

When the user is not sensed, the first display apparatus 100-1 may release the communication connection with the remote control device 200. When a distance between the first display apparatus 100-1 and the remote control device 200 is greater than a predetermined distance, the first display apparatus 100-1 may release the communication connection with the remote control device 200.

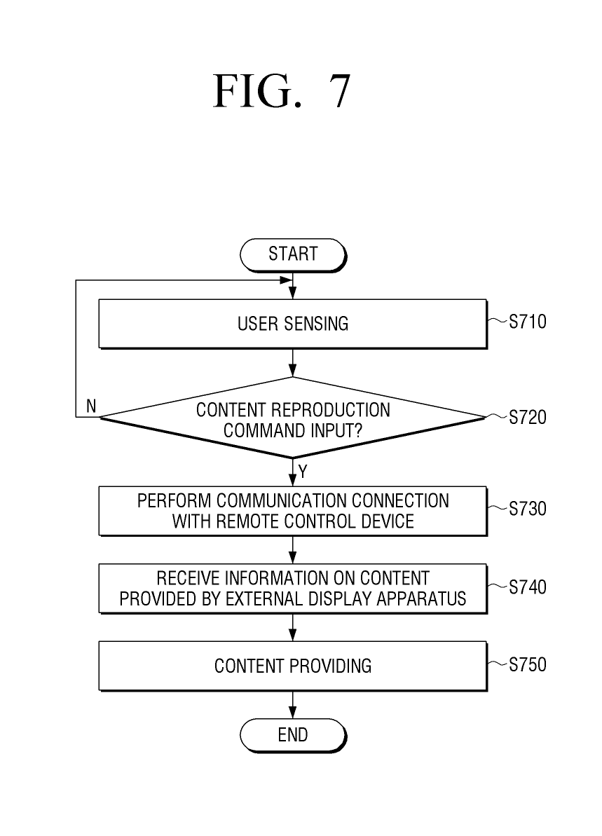

FIG. 7 is a flowchart illustrating an example method for providing a content of a display apparatus according to an example embodiment of the present disclosure.

The display apparatus 100 may sense a user at step S710. The display apparatus 100 may sense a user using, for example, and without limitation, a camera, an infrared sensor, or the like.

When a content reproduction command is input to the remote control device 200 at step S720-Y, the display apparatus 100 may perform a communication connection with the remote control device 200 at step S730. When a content reproduction command is input to the remote control device 200, the remote control device 200 may transmit a pairing request signal to the display apparatus 100, and the display apparatus 100 may identify whether a user is sensed upon the reception of the pairing request signal, transmit a pairing response signal to the remote control device 200, and perform a communication connection with the remote control device 200. When a content reproduction command is not input to the remote control device 200 at step S720-N, the display apparatus may continue monitoring for user sensing.

According to another embodiment, at step S730, the operation at step S710 may be performed. The display apparatus 100 may sense the user when a pairing request signal is received from the remote control device 200.

After the communication connection is performed, the display apparatus 100 may receive information on a content provided by an external display apparatus from the remote control device 200 at step S740. The information on the content may include identification information on the content provided by the external display apparatus and reproduction information.

The display apparatus 100 may provide a content based on information on the received content at step S750. The display apparatus 100 may display an inquiry message for inquiring whether a content is provided, and if a reproduction command is input through the inquiry message, a content may be reproduced. In addition, the display apparatus 100 may continuously provide the content provided by the external display apparatus based on the reproduction information included in the information on the content.

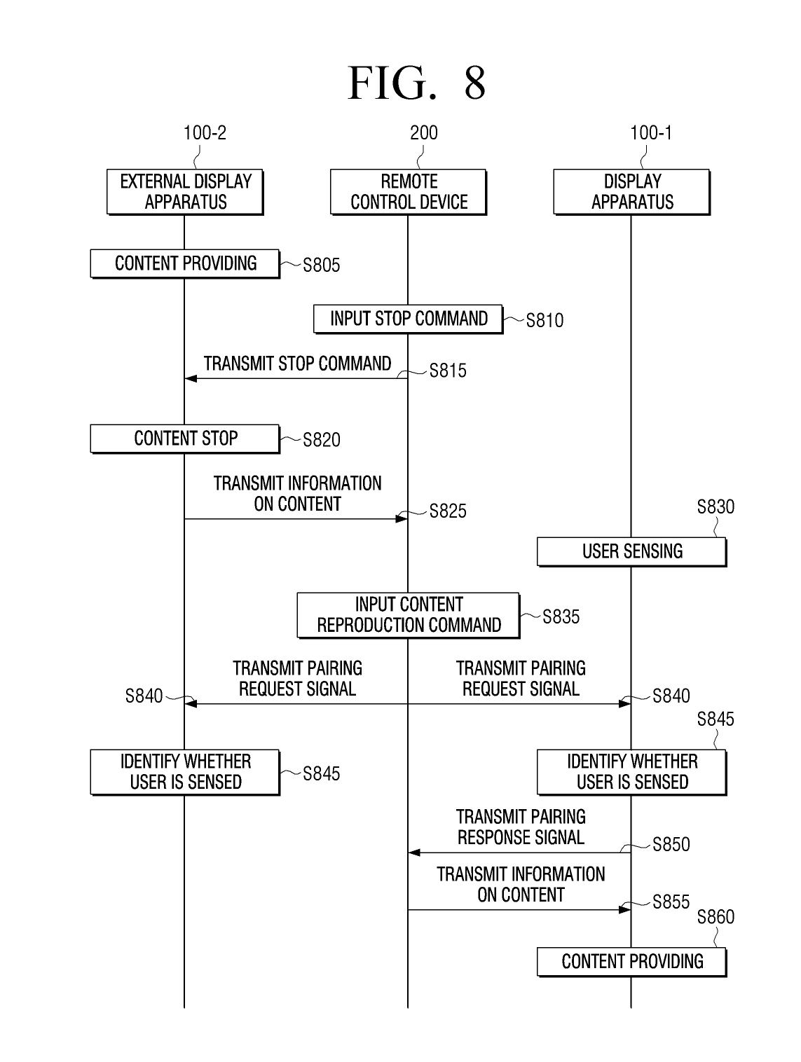

FIG. 8 is a sequence diagram illustrating an example method for providing a content of a content providing system according to an example embodiment of the present disclosure. A display apparatus 100-1 and an external display apparatus 100-2 may be display apparatuses disposed in separate spaces, and the remote control device 200 may be an integrated remote controller which controls a plurality of display apparatuses 100-1 and 100-2.

The external display apparatus 100-2 may provide a content at step S805. The connect may be a broadcast content, but is not limited thereto, and may be one of various contents such as a web content, an application content, a music content, etc.

The remote control device 200 may receive a stop command at step S810. The stop command may be a command for selecting a stop button provided in the remote control device 200 or a user voice command for stopping a content through a microphone provided in the remote control device 200.

The remote control device 200 may transmit a stop command to the external display apparatus 100-2 at step S815. The stop command may include a query for requesting information on a content.

The external display apparatus 100-2 may stop the content in response to the stop command at step S820, and transmit the information on the content to the remote control device 200 at step S825. The information on the content may include identification information on a content provided by the external display apparatus 100-2 and reproduction information on a point of time when the stop command is input. The external display apparatus 100-2 may stop the content, and when a user is not sensed, may change a mode to a standby mode.

The display apparatus 100-1 may sense a user at step S830. In other words, after a user moves from a position where the external display apparatus 100-2 is present to a position where the display apparatus 100-1 is present, the display apparatus 100-1 may sense the user.

The remote control device 200 may receive a content reproduction command at step S835. The content reproduction command may include a command for selecting a specific button included in the remote control device 200 or a user voice command for reproducing the content input through the microphone included in the remote control device 200.

When a content reproduction command is input, the remote control device 200 may transmit a pairing request signal at step S840. The pairing request signal may be transmitted to the outside by way of broadcasting to an arbitrary device.

When receiving a pairing request signal, the external display apparatus 100-2 and the display apparatus 100-1 may identify whether the user is sensed at step S845. When it is determined that the user is not sensed, the external display apparatus 100-2 may not transmit a pairing response signal. When identifying the use is sensed, the display apparatus 100-1 may transmit a paring response signal at step S850.

When receiving the pairing response signal, the remote control device 200 may transmit information on a content to the display apparatus 100-1 at step S855. The remote control device 200 may transmit a content reproduction command together with information on a content.

The display apparatus 100-1 may provide a content based on the information on the content at step S860.

According to various embodiments of the present disclosure as described above, a user could continuously watch a content by more intuitively and conveniently using a plurality of display apparatuses.

A device (e.g., modules, a display device 100, or a remote control device 200) or a method (e.g., operations) in accordance with various embodiments may be performed by at least one computer (e.g., a processor) which executes a command included in at least one program among programs maintained by computer-readable storage media.

When the command is executed by a computer (e.g., a processor), the at least one computer may perform a function corresponding to the command. In this case, the computer-readable storage medium may be, for example, the memory (160 or 220).

The program may be stored in a computer readable recording medium such as a hard disk, a floppy disk, a magnetic medium (e.g., a magnetic tape), an optical medium (e.g., a compact disc read only memory (CD-ROM)), a digital versatile discs (a DVD), magneto-optical media (e.g., a floptical disk), a hardware device (e.g., read only memory (ROM)), a random access memory (RAM), a flash memory, etc.). In this case, the storage medium may be generally included as part of the configuration of the display device 100, but it may be mounted through a port of the display device 100, or included in an external device outside the display device 100 (e.g., a cloud, a server, or other electronic device). The program may be divided into a plurality of storage media, and at least part of a plurality of storage media may be located in the external device of the display device 100.

The commands may include high-level language code that may be executed by a computer using an interpreter or the like as well as machine language code such as those generated by a compiler. The hardware devices described above may be configured to operate as one or more software modules to perform the operations of the various embodiments, and vice versa.

Although various example embodiments have been illustrated and described, it will be appreciated by those skilled in the art that various changes may be made to these example embodiments without departing from the principles and spirit of the present disclosure. Accordingly, the scope of the present disclosure is not to be understood as being limited to the described example embodiments, but is defined, for example, by the appended claims as well as equivalents thereto.

What is claimed is:

1. A method for providing a content of a display apparatus, the method comprising:
sensing a user;
performing a communication connection with a remote control device based on a content reproduction command being input to the remote control device after the user is sensed;
receiving information on a content provided by an external display apparatus from the remote control device; and
providing the content provided by the external display apparatus based on the information on the content.

2. The method as claimed in claim 1, wherein in a case where the remote control device transmits a stop command to the external display apparatus while the external display apparatus provides the content, the remote control device receives and stores the information on the content provided by the external display apparatus.

3. The method as claimed in claim 2, wherein the information on the content provided by the external display apparatus includes reproduction information on a point of time when the stop command is input, and
wherein the providing comprises continuously providing a content provided by the external display apparatus at the point of time when the stop command is input based on the reproduction information on the point of time when the stop command is input.

4. The method as claimed in claim 1, wherein the information on the content provided by the external display apparatus includes at least one of: metadata information on a broadcast content, web address information on a web content, information on an application content, and information on a music content.

5. The method as claimed in claim 1, wherein the providing comprises:
displaying an inquiry message for reproducing the content provided by the external display apparatus based on the information on the content being received; and
providing the content provided by the external display apparatus based on the information on the content based on a content reproduction command being input thorough the inquiry message.

6. The method as claimed in claim 1, further comprising:
releasing the communication connection with the remote control device based on the user not being sensed.

7. The method as claimed in claim 1, further comprising:
transmitting content reproduction information at a point of time when a stop command is input to the remote control device based on the stop command being received from the remote control device while the content is reproduced.

8. The method as claimed in claim 1, wherein the performing of the communication connection comprises:
receiving a pairing request signal from the remote control device based on the content reproduction command being input to the remote control device;
identifying whether a user is sensed based on the pairing request signal being received; and
transmitting a pairing response signal in response to the pairing request signal based on the user being sensed.

9. A display apparatus, comprising:
a sensor configured to sense a user;
a communicator comprising communication circuitry configured to perform communication with a remote control device;
a display; and
a processor configured to control the communicator to perform a communication connection with a remote control device based on a content reproduction command being input to the remote control device after a user is sensed through the sensor, to control the communicator to receive information on a content provided by an external display apparatus from the remote control device, and
to control the display to provide the content provided by the external display apparatus based on the information on the content.

10. The display apparatus as claimed in claim 9, wherein the remote control device is configured to receive and store the information on the content provided by the external display apparatus in a case where the remote control device transmits a stop command to the external display apparatus while the external display apparatus provides the content.

11. The display apparatus claimed in claim 10, wherein the information on the content provided by the external display device includes reproduction information on a point of time when the stop command is input, and
wherein the processor is further configured to control the display to continuously provide a content provided by the external display apparatus at the point of time when the stop command is input based on the reproduction information on the point of time when the stop command is input.

12. The display apparatus as claimed in claim 9, wherein the information on the content provided by the external display apparatus includes at least one of:
metadata information on a broadcast content, web address information on a web content, information on an application content, and information on a music content.

13. The display apparatus as claimed in claim 9, wherein the processor is further configured to:
control the display to display an inquiry message for reproducing the content provided by the external display apparatus based on the information on the content being received, and
control the display to provide the content provided by the external display apparatus based on the information on the content based on a content reproduction command being input through the inquiry message.

14. The display apparatus as claimed in claim 9, wherein the processor is further configured to control the communicator to release a communication connection with the remote control device based on the user not being sensed through the sensor.

15. The display apparatus as claimed in claim 9, wherein the processor is further configured to control the communicator to transmit content reproduction information at a point of time when a stop command is input to the remote control device, based on the stop command being received from the remote control device while the content is reproduced.

16. The display apparatus as claimed in claim 9, wherein the processor is further configured to:
receive a pairing request signal from the remote control device through the communicator based on the content reproduction command being input to the remote control device,
identify whether a user is sensed based on the pairing request signal being received, and
perform the communication connection by transmitting a pairing response signal in response to the pairing request signal through the communicator based on the user being sensed.
